(19) United States
(12) Patent Application Publication
(10) Pub. No.: US 2016/0364454 A1
(43) Pub. Date: Dec. 15, 2016

(54) COMPUTING SYSTEM WITH CONTEXTUAL SEARCH MECHANISM AND METHOD OF OPERATION THEREOF

(71) Applicant: Telenav, Inc., Sunnyvale, CA (US)

(72) Inventors: Jianyi Yang, Santa Clara, CA (US); Kumar Maddali, San Ramon, CA (US)

(21) Appl. No.: 14/736,083

(22) Filed: Jun. 10, 2015

(51) Int. Cl. G06F 17/30

(52) U.S. Cl. CPC G06F 17/30528; G06F 17/3053; G06F 17/30867

(57) ABSTRACT

A method of operation of a computing system includes: determining a search input; determining a user context associated with the search input for representing the user providing the search input; generating dynamic factor adjustments for candidate costs based on the user context; and determining a target result based on the dynamic factor adjustment and the candidate costs in response to the search input.

### TECHNICAL FIELD

An embodiment of the present invention relates generally to a computing system, and more particularly to a system with a contextual search mechanism.

### BACKGROUND ART

Modern consumer and industrial electronics, especially devices such as graphical computing systems, televisions, projectors, cellular phones, portable digital assistants, and combination devices, are providing increasing levels of functionality to support modern life including location-based information services. Research and development in the existing technologies can take a myriad of different directions.

As users become more empowered with the growth of mobile communication technology, new and old paradigms begin to take advantage of this new space. One such space is location-based functions for devices. The possible applications for balancing variety of features with user's relevant context have yet been fully utilized.

Thus, a need still remains for a computing system with a contextual search mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

An embodiment of the present invention provides a method of operation of a computing system including: determining a search input; determining a user context associated with the search input for representing the user providing the searching input; generating dynamic factor adjustments for candidate costs based on the user context; and determining a target result based on the dynamic factor adjustment and the candidate costs in response to the search input.

An embodiment of the present invention provides a computing system, including: a storage interface configured to determine a search input; and a control unit, coupled to the storage interface, configured to: determine a user context associated with the search input for representing the user providing the searching input, generate dynamic factor adjustments for candidate costs based on the user context, and determine a target result based on the dynamic factor adjustment and the candidate costs in response to the search input.

An embodiment of the present invention provides a non-transitory computer readable medium including instructions for a computing system, including: determining a search input; determining a user context associated with the search input for representing the user providing the searching input; generating dynamic factor adjustments for candidate costs based on the user context; and determining a target result based on the dynamic factor adjustment and the candidate costs in response to the search input.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with a contextual search mechanism in an embodiment of the present invention.

FIG. 2 is an example of a display interface of the computing system.

FIG. 3 is a further example of the display interface of the computing system.

FIG. 4 is an exemplary block diagram of the computing system.

FIG. 5 is a control flow of the computing system.

FIG. 6 is a flow chart of a method of operation of a computing system in an embodiment of the present invention.

### BEST MODE FOR CARRYING OUT THE INVENTION

The following embodiments can be for determining a target result based on user context in response to a search input. The target result can be determined based on evaluating multiple candidate costs according to a dynamic factor adjustment. The dynamic factor adjustment can represent a real-time importance, significance, availability, or a combination thereof for the candidate costs for user according to the user context. The dynamic factor adjustment can be used to evaluate candidate results according to the real-time importance, significance, availability, or a combination thereof of the user in determining the target result.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

One skilled in the art would appreciate that the format with which navigation information is expressed is not critical to some embodiments of the invention. For example, in some embodiments, navigation information is presented in the format of (X, Y); where X and Y are two coordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein can include the navigation information described as well as information relating to points of interest to the user, such as local business, hours of businesses, types of businesses, advertised specials, traffic information, maps, local events, and location based community or personal information.

The term “module” referred to herein can include or be implemented as software, hardware, or a combination thereof in the present invention in accordance with the context in which the term is used. For example, the software can be machine code, firmware, embedded code, and application software. The software can also include a function, a call to a function, a code block, or a combination thereof. Also for example, the hardware can be gates, circuitry, processor, computer, integrated circuit, integrated circuit cores, a pressure sensor, an inertial sensor, a microelectromechanical system (MEMS), passive devices, physical non-transitory memory medium having instructions for performing the software function, a portion therein, or a combination thereof.

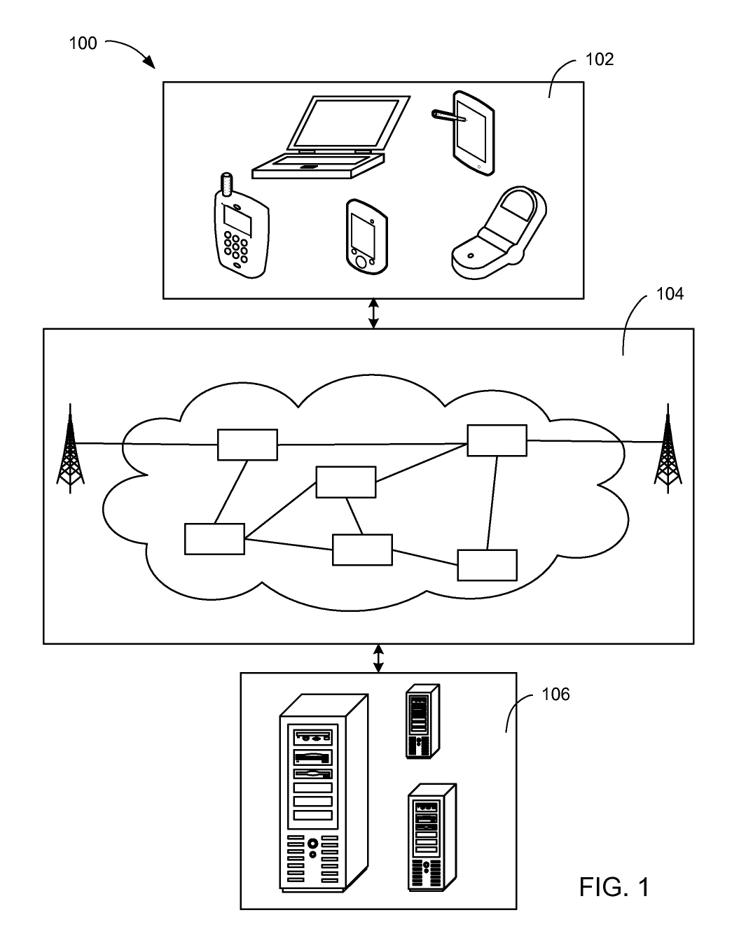

Referring now to FIG. 1, therein is shown a computing system 100 with a contextual search mechanism in an embodiment of the present invention. The computing system 100 can include a first device 102, such as a client or a server, connected to a second device 106, such as a client or server. The computing system 100 can include a navigation system for searching or providing guidance or information associated with geographic locations, a regulatory system for enabling access to a device or a vehicle, or a combination thereof. The first device 102 can communicate with the second device 106 with a network 104, such as a wireless or wired network.

For example, the first device 102 can be of any of a variety of computing devices, such as a cellular phone, personal digital assistant, a notebook computer, automotive telematics navigation system, or other multi-functional mobile communication or entertainment device. Also for example, the first device 102 can include a device or a sub-system for enabling access to a device or a vehicle, including an ignition interlock device.

The first device 102 can couple, either directly or indirectly, to the network 104 to communicate with the second device 106 or can be a stand-alone device. The first device 102 can further be separate form or incorporated with a vehicle, such as a car, truck, bus, or train.

For illustrative purposes, the computing system 100 is described with the first device 102 as a mobile computing device, although it is understood that the first device 102 can be different types of devices. For example, the first device 102 can also be a non-mobile computing device, such as a server, a server farm, or a desktop computer.

The second device 106 can be any of a variety of centralized or decentralized computing devices, or video transmission devices. For example, the second device 106 can be a computer, grid computing resources, a virtualized computer resource, cloud computing resource, routers, switches, peer-to-peer distributed computing devices, or a combination thereof.

The second device 106 can be centralized in a single room, distributed across different rooms, distributed across different geographical locations, embedded within a telecommunications network. The second device 106 can couple with the network 104 to communicate with the first device 102. The second device 106 can also be a client type device as described for the first device 102.

For illustrative purposes, the computing system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, such as a car, a truck, a bus, or a train.

Also for illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the network 104, although it is understood that the computing system 100 can have a different partition between the first device 102, the second device 106, and the network 104. For example, the first device 102, the second device 106, or a combination thereof can also function as part of the network 104.

The network 104 can span and represent a variety of networks. For example, the network 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the network 104. Further, the network 104 can traverse a number of network topologies and distances. For example, the network 104 can include direct connection, personal area network (PAN), local area network (LAN), metropolitan area network (MAN), wide area network (WAN), or a combination thereof.

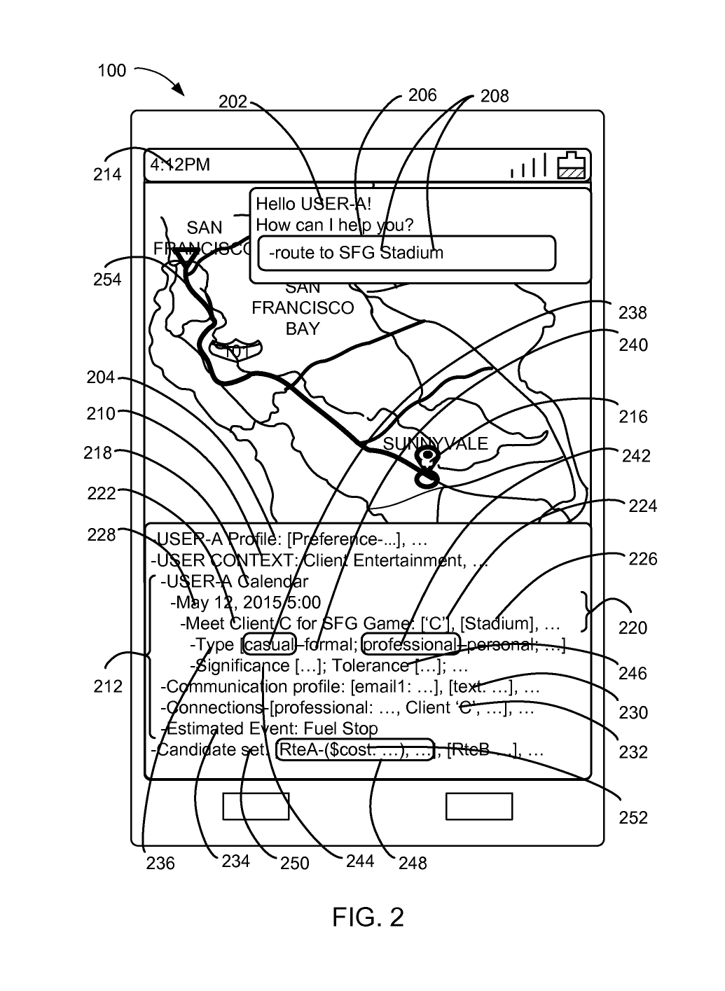

Referring now to FIG. 2, therein is shown an example of a display interface of the computing system 100. The computing system 100 can show a representation of a user 202. The user 202 can include a person or an entity associated with the computing system 100 or a device therein, such as the first device 102 of FIG. 1, the second device 106 of FIG. 1, or a combination thereof. The user 202 can own, operate, access, possess, or a combination thereof for the device of the computing system 100. The user 202 can further interface with the device or have the device on the person of the user 202.

The computing system 100 can use a user profile 204 for identifying the user 202. The user profile 204 can include a description or a representation of the user 202.

The user profile 204 can include user identification, such as a name, a government-issued identification information, an account name or identification, a contact information, physical features or traits, audible features or traits, or a combination thereof. The user profile 204 can further include access information, such as accounts, passwords, access methods, enrollment status, or a combination thereof. For example, the user profile 204 can include information regarding a social networking account or membership for the user 202, a link or a password thereto, an access protocol, or a combination thereof.

The user profile 204 can further include demographics information or professional description of the user 202. For example, the user profile 204 can include age, sex, education level or certification, experience or qualification, previous employer, current employer, information regarding professional relationship within an organization, such as a supervisor or a subordinate, information regarding professional relationship to a third party, such as a client or a supplier, job title, job description, or a combination thereof

The user profile 204 can further include previous uses, parameters, interactions, results, or a combination thereof. For example, the user profile 204 can include usage history of the first device 102, the second device 106, or a combination thereof. Also for example, the user profile 204 can include usage profile specific to the user 202. Also for example, the user profile 204 can include previous locations travelled or occupied by the user 202. Also for example, the user profile 204 can include previous outputs, search information, processing results, or a combination thereof.

The user profile 204 can further include preferences or settings specific for the user 202. The user profile 204 can include a representation of a pattern, an affinity or a likelihood, or a combination thereof for the user 202. The user profile 204 can further include a configuration, an arrangement, a limit, or a combination thereof for the first device 102, the second device 106, a function thereof, or a combination thereof as dictated by the user 202.

The user 202 can interact with the computing system 100 using a search input 206. The search input 206 can include information received from the user 202 representing a request to find particular information. The search input 206 can include a letter, a number, a symbol, a word, an image, a sound, or a combination thereof. For example, the search input 206 can include a character string or a phrase.

The search input 206 can include one or more search terms 208 each representing a unit of independent information. The user 202 can request to find information fitting or matching a particular combination of the search terms 208 within the search input 206. For example, the search input 206 can include a search for a website, a link, a term or a concept, an object, an entity, a person, a contact information, or a combination thereof. Also for example, the search input 206 can include a request for navigational information, such as a destination or a Point of Interest (POI), a route thereto, an estimated arrival time thereto, or a combination thereof.

The search input 206 can include a request for information internal to the first device 102, the second device 106, or a combination thereof. The search input 206 can include a request for information external and accessible to the first device 102, the second device 106, or a combination thereof, such as over a computer network or on another connected database.

The computing system 100 can determine user context 210. The user context 210 can include a representation of a situation, an environment, a purpose, a significance, or a combination thereof regarding the user 202. The user context 210 can include data or information associated with or relevant to the user 202.

The user context 210 can include a label, a value, a cluster, a model, a categorization, or a combination thereof representing the purpose, the goal, the meaning, the significance, the category, the affinity, or a combination thereof associated with the user 202. For example, the user context 210 can include a value or a selection representing work activity, leisure activity, group travel, importance or value to the user 202, regularity or irregularity of the activity, importance or value to a party other than the user 202, or a combination thereof

The user context 210 can be information external to the search input 206. The user context 210 can be associated with the search input 206. For example, the user context 210 can represent a motivation or a reason for the search input 206. Also for example, the user context 210 can represent a further use or application of the information desired or described by the search input 206. The computing system 100 can utilize the user context 210 in determining information matching the search input 206.

The user context 210 can include or be based on contextual parameters 212 representing determinable aspect of a current circumstance or situation for the user 202. The contextual parameters 212 can include data or information representing an aspect of a current circumstance or situation of the user 202 associated with the travels of the user 202. The contextual parameters 212 can include processing results of the computing system 100, results from processing a set of the contextual parameters 212, or a combination thereof.

For example, the contextual parameters 212 can include content or value of specific data, metadata, preference information, setting, configuration, a portion thereof, a representation thereof, or a combination thereof. Also for example, the contextual parameters 212 can include data or information associated with movement or travel of the user 202, schedule or calendar of the user 202, communications of the user 202, time, groups or relationships of the user 202, current environment, or a combination thereof.

As a more specific example, the contextual parameters 212 can include current time 214, current location 216, a schedule calendar 218, or a combination thereof. The current time 214 and the current location 216 can be for the user 202, the first device 102, the second device 106, or a combination thereof. The current location 216 can include navigation information, such as coordinates or address, representing the geographic location of the user 202 or the first device 102.

The schedule calendar 218 can represent actions, ideas or thoughts, events, or a combination thereof according to time. For example, the schedule calendar 218 can include an electronic schedule or a personal assistant application.

The schedule calendar 218 can include a calendar event 220. The calendar event 220 can represent an occurrence or happening, or a social gathering at a given date or time. The calendar event 220 can include a representation of purpose, title, or name given to the occurrence, happening, or a social gathering. The calendar event 220 can further include an event title 222, an event participant 224, an event location 226, a time associated with the calendar event 220, such as an event start time 228 or a duration.

The event title 222 can include an identification of the calendar event 220. The event title 222 can include the name, the title, the purpose, or a combination thereof identifying the calendar event 220. The event title 222 can further include a link, a pointer, an address, or a combination thereof for accessing the calendar event 220.

The event participant 224 can include a person, an organization, an entity, or a combination thereof taking part in the calendar event 220 with the user 202. The event participant 224 can include a host, an invitee, an organizer, a promoter, or a combination thereof. The event participant 224 can include a party that was, is, or is scheduled to be at the event location 226 during the calendar event 220.

The event location 226 can include a representation of geographic location or region of the calendar event 220. The event location 226 can include a building, a room, an area identified by boundaries, or a combination thereof. The event location 226 can include an address, a set of cross streets, a famous landmark, a set of coordinates, or a combination thereof. The event location 226 can include a web page address, a Net Meeting identifier, a link, a server address or name, or a combination thereof.

The event start time 228 can include a time marking a beginning of the calendar event 220. The calendar event 220 can further be represented by other time values, such as a duration, a calendar end time, a time remaining, or a combination thereof.

Also as a more specific example, the contextual parameters 212 can include a communication profile 230, a relationship profile 232, an estimated event 234, or a combination thereof. The communication profile 230 can include information associated with communications involving the user 202.

The communication profile 230 can include information associated with the user 202 as a recipient or a sender. The communication profile 230 can include information associated with various forms of communications, such as telephone or voice communication, an email, a phone text message, an instant messaging application, an upload or a download, or a combination thereof.

The communication profile 230 can include a content of the communication, such as for an inbox or saved messages, metadata or a description for the communication, such as for time of occurrence or size, identification of corresponding communication party, or a combination thereof. The communication profile 230 can further include an address book including identification or contact information for various potential or previous communication parties.

The relationship profile 232 can include a representation of social familiarity, personal connection, professional association, or a combination thereof for the user 202. The relationship profile 232 can include identification of a person, an organization, an entity, or a combination thereof having social familiarity, personal connection, professional association, or a combination thereof for the user 202.

For example, the relationship profile 232 can include a set of connections for the user 202 on a social media service, an address book or a contact set on a personal device of the user 202, or a combination thereof. Also for example, the relationship profile 232 can include a representation of a type of relationship, a degree of familiarity, a number or a frequency of encounters, a duration of familiarity, or a combination thereof between the user 202 and a corresponding party.

The estimated event 234 can include a prediction for an occurrence or a happening for the user 202. The estimated event 234 can include the occurrence or the happening not listed in the schedule calendar 218, but corresponds to a high likelihood of attendance or participation by the user 202.

The computing system 100 can generate the estimated event 234. The computing system 100 can generate the estimated event 234 based on a variety of factors, such as other instances of the contextual parameters 212, the user profile 204, or a combination thereof.

For example, the computing system 100 can generate the estimated event 234 occurring at the end of the user's current travel based on a heading, a direction, a route, the current time 214, a previous location or a starting point, or a combination thereof for the current travel. Also for example, the computing system 100 can generate the estimated event 234 based on the communication profile 230, the relationship profile 232, user's previous history, a pattern for the user 202, a history or a preceding instance of the search input 206, or a combination thereof. Details regarding the estimated event 234 are discussed below.

The computing system 100 can further determine categorizations or descriptions corresponding to abstract meanings or values for the user context 210. For example, the computing system 100 can determine a context type 236 for the user 202. The context type 236 is a representation of a classification for a goal or an objective corresponding to the user context 210.

The context type 236 can correspond to the goal or the objective behind or overarching the search input 206. The context type 236 can correspond to the goal or the objective of the user 202 at the current time 214, for the upcoming instance of the calendar event 220 or the estimated event 234, or a combination thereof. The context type 236 can be a value, a label, an identification of a category, or a combination thereof from within a set predetermined by the computing system 100.

As a more specific example, the context type 236 can include a casual designation 238, a formal designation 240, a professional designation 242, or a combination thereof. The casual designation 238 can include a specific value or instance of the context type 236. The casual designation 238 represents informal nature or categorization for the user 202, such as for the current time 214, for the calendar event 220 or the estimated event 234, or a combination thereof. The formal designation 240 can be opposite of the casual designation 238, and represent an official nature or classification for the user 202.

The professional designation 242 represents the user context 210 associated with employment or career of the user 202. The professional designation 242 can include the current time 214, the calendar event 220, the estimated event 234, or a combination thereof occurring at a place of employment, including coworkers or other professional contact, or a combination thereof. The professional designation 242 can include a training activity, an educational activity, a business development activity, a networking activity, or a combination thereof.

For illustrative purposes only a limited number of values or categories have been described for the context type 236. However, it is understood that the context type 236 can include numerous other values or categories, such as an internal-facing designation or an external-facing designation with respect to a grouping or a membership of the user 202, a long-term or a short-term categorization, or a combination thereof

Also for example, the computing system 100 can calculate a significance rating 244. The significance rating 244 is a representation of a value or an importance associated with the user context 210. The significance rating 244 can represent the value or the importance for activity or occurrence at the current time 214, for the calendar event 220 or the estimated event 234, the search input 206 or the user context 210 associated thereto, or a combination thereof.

Also for example, the computing system 100 can calculate a tolerance rating 246. The tolerance rating 246 is a representation of a degree of deviation acceptable to the user 202. The tolerance rating 246 can be for a corresponding factor associated with the user context 210, the search input 206, or a combination thereof

For example, the tolerance rating 246 can represent an acceptability of a late arrival for the calendar event 220 or the estimated event 234. Also for example, the tolerance rating 246 can represent an amount of physical activity likely preferred by the user 202 for the calendar event 220 or the estimated event 234. Also for example, the tolerance rating 246 can represent a tolerable amount of money associated with the search input 206.

The computing system 100 can determine a target result 248 for the search input 206 based on the user context 210. The target result 248 is an estimate of the computing system 100 for responding to the search input 206. The target result 248 can be information matching the search input 206 along with the user context 210. The target result 248 can be one or a set of answers generated or provided by the computing system 100 to address or to respond to the search input 206.

The computing system 100 can determine the target result 248 from a candidate set 250. The candidate set 250 is a grouping of information with potential applicability as the target result 248. The candidate set 250 can be the grouping of information being analyzed by the computing system 100 in determining the target result 248.

The computing system 100 can determine the target result 248 from the candidate set 250. The computing system 100 can determine the target result 248 from the candidate set 250 based on a candidate cost 252. The candidate cost 252 is a representation of amount of resources associated with an instance of a candidate result within the candidate set 250. The candidate cost 252 can represent an amount of resources the user 202 would have to spend or consume in following through with the candidate result. For example, the candidate cost 252 can include time, money, physical energy, device energy, safety risk, a probability of a reactive event, or a combination thereof.

The computing system 100 can balance and evaluate the candidate cost 252 in accordance with the user context 210. The computing system 100 can determine the target result 248 from the candidate set 250 according to the balance and evaluation of the candidate cost 252 appropriate for the user context 210.

As a specific example, the user 202 can request for a navigation route 254 with the search input 206. The computing system 100 can include a navigation system. The user 202 can request the navigation route 254 for traveling to the calendar event 220 or the estimated event 234. Depending on the user context 210 unique to the user 202 or the current time 214, the computing system 100 can calculate the navigation route 254.

Continuing with the example, the user 202 may be willing to spend relatively large amount of money to arrive early or on-time for important events, while unwilling to spend the same amount for casual events. The user 202 may also be willing to wait a long time for a restaurant or a cuisine highly rated by others or normally preferred by the user 202, while not likely to wait the same amount of time for other types of restaurants or cuisines. The computing system 100 can calculate the navigation route 254 as the target result 248 appropriate for the user context 210 based on analyzing and evaluating the candidate cost 252. Details regarding processing for the target result 248 are discussed below.

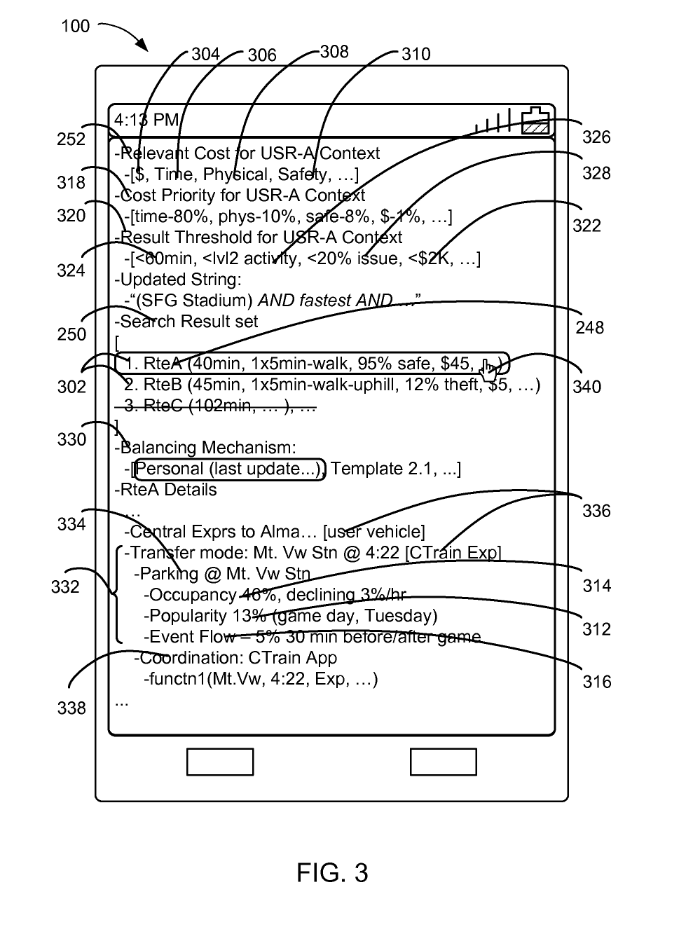

Referring now to FIG. 3, therein is shown a further example of the display interface of the computing system 100. The display interface can show details for processing the target result 248. For example, the display interface can show details regarding the candidate set 250, the candidate cost 252.

The candidate set 250 can include a candidate ranking 302. The candidate ranking 302 is a representation of relative desirability for the candidates within the candidate set 250. The candidate ranking 302 can be a sequence, a score, a value, or a combination thereof representing the desirability of each candidate within the candidate set 250.

For example, the candidate ranking 302 can be an arrangement or an order of preference for the candidates. Also for example, the candidate ranking 302 can be an estimated match or appropriateness for the candidate with respect to the search input 206 of FIG. 2, the user context 210 of FIG. 2, the user profile 204 of FIG. 2, or a combination thereof.

The computing system 100 can generate the candidate ranking 302 for the candidate set 250. The computing system 100 can generate the candidate ranking 302 based on the search input 206, the user context 210, the user profile 204, or a combination thereof. Details regarding the candidate ranking 302 are discussed below.

The candidate cost 252 can include a monetary cost 304, a time cost 306, a physical cost 308, a safety rating 310, or a combination thereof. The monetary cost 304 is an amount of financial resource associated with an instance of a candidate result or a portion therein within the candidate set 250.

The monetary cost 304 can represent the amount of money required for the corresponding candidate. For example, the monetary cost 304 can represent the money necessary to complete the travel over the navigation route 254 of FIG. 2 or a candidate thereof, including toll fees, parking cost, entrance or exit fee, public transportation fee, private transportation fee, gas bill, or a combination thereof.

The time cost 306 is a representation of an amount of time associated with an instance of a candidate result or a portion therein within the candidate set 250. The time cost 306 can represent the amount of time necessary to complete or utilize the corresponding candidate. For example, the time cost 306 can represent the amount of time necessary to traverse the navigation route 254 or a candidate thereof, travel over any segment therein, a delay associated with any stops or changes in modes therein, or a combination thereof.

The physical cost 308 is a representation of an amount of physical energy or activity associated with an instance of a candidate result or a portion therein within the candidate set 250. The physical cost 308 can represent the amount of physical activity required of the user 202 of FIG. 2 to complete or utilize the corresponding candidate. For example, the physical cost 308 can include an estimate on a duration or a difficult of walk required in the navigation route 254 or a candidate thereof.

The safety rating 310 is a representation of security or well-being associated with an instance of a candidate result or a portion therein within the candidate set 250. The safety rating 310 can represent a level of security or wellness for the user 202 in completing or utilizing the corresponding candidate. For example, the safety rating 310 can include an accident rate or a crime rate associated with the navigation route 254, a candidate thereof, an area associated thereto, or a combination thereof

The candidate cost 252 can be based on an external popularity 312 for a candidate result. The computing system 100 can determine the candidate cost 252 based on the external popularity 312.

The external popularity 312 is a representation of attractiveness of a particular candidate option to people other than the user 202. The candidate cost 252 can represent a likelihood of availability for the candidate result with limited supply or accommodation. For example, the external popularity 312 can include an occupancy measure 314, an event-based flow 316, or a combination thereof.

The occupancy measure 314 is a representation of tenancy or use for a corresponding candidate result. The occupancy measure 314 can represent a current demand, a current use or tenancy, or a combination thereof for the candidate result. The occupancy measure 314 can further represent available amount of resources or services for the corresponding candidate result. The occupancy measure 314 can be for the current time 214 of FIG. 2, for a later time, a time before the event start time 228, the start of the estimated event 234 of FIG. 2, or a combination thereof.

The event-based flow 316 is a pattern for the occupancy measure 314 relative to a particular event or occasion. The event-based flow 316 can represent an increase in the occupancy measure 314 associated with other events or occasions affecting the candidate result. For example, the event-based flow 316 can represent a pattern in the occupancy measure 314 for hotels or parking lots associated with start or end of an event or an occasion at a nearby entity or location.

The candidate cost 252 can be associated with a dynamic factor adjustment 318. The dynamic factor adjustment 318 is a representation of relative importance or significance for the various instances of the candidate cost 252. The dynamic factor adjustment 318 can represent the relative importance or significance of various different costs or factors according to the user context 210, the search input 206, or a combination thereof

The dynamic factor adjustment 318 can include a sequence, a score, a value, or a combination thereof representing the importance or significance of each type or instance of the candidate cost 252, such as the monetary cost 304, the time cost 306, the physical cost 308, the safety rating 310, or a combination thereof. The dynamic factor adjustment 318 can further include a weight or an adjustment factor corresponding to one or more instance or category of the candidate cost 252.

The computing system 100 can use a dynamic threshold set 320 for processing the target result 248. The dynamic threshold set 320 is a group of limitations used for determining the target result 248. The dynamic threshold set 320 can include a value, such as a maximum or a minimum, a range, a condition, or a combination thereof

The dynamic threshold set 320 can be used to generate the candidate set 250. The dynamic threshold set 320 can be used as a requirement for the candidate results in the candidate set 250 corresponding to the search input 206 and the user context 210. The dynamic threshold set 320 can be calculated or adjusted based on the user profile 204, the search input 206, the user context 210, or a combination thereof.

The dynamic threshold set 320 can correspond to the candidate cost 252. For example, the dynamic threshold set 320 can include a monetary threshold 322, a time threshold 324, a physical threshold 326, a safety threshold 328, or a combination thereof.

The monetary threshold 322 is a limitation for the monetary cost 304. The monetary threshold 322 can include a maximum price, a minimum price, or a combination thereof appropriate for the user context 210 in response to the search input 206.

The time threshold 324 is a limitation for the time cost 306. The time threshold 324 can include a maximum time or duration, a minimum time or duration, or a combination thereof appropriate for the user context 210 in response to the search input 206.

The physical threshold 326 is a limitation for the physical cost 308. The physical threshold 326 can include a maximum, a minimum, or a combination thereof for a level physical exertion or activity appropriate for the user context 210 in response to the search input 206.

The safety threshold 328 is a limitation for the safety rating 310. The safety threshold 328 can include a maximum, a minimum, or a combination thereof for risks associated with well-being appropriate for the user context 210 in response to the search input 206.

The computing system 100 can use a balancing mechanism 330 for determining the target result 248, for generating the candidate set 250, or a combination thereof. The balancing mechanism 330 is a method or a process for generating the dynamic factor adjustment 318, the dynamic threshold set 320, or a combination thereof. The balancing mechanism 330 can evaluate the various parameters according to the user context 210 in processing the search input 206.

The balancing mechanism 330 can be implemented using circuitry, software, application, a function, an instruction, or a combination thereof. The balancing mechanism 330 can be predetermined by the computing system 100.

The computing system 100 can use the balancing mechanism 330 to generate dynamic factor adjustment 318, the dynamic threshold set 320, or a combination thereof in generating the candidate set 250. For example, the computing system 100 can generate the navigation route 254 in response to the search input 206 and appropriate for the user context 210. The computing system 100 can generate multiple candidate routes for the candidate set 250. The multiple candidate routes can include a door-to-door route including one or more instances of a route accommodation 332.

The route accommodation 332 is a location, an entity, a service, or a combination thereof separate from a path or a node accessible to one mode of travel for the user 202. For example, the route accommodation 332 can further include a parking solution 334, a change in a travel mode 336, or a combination thereof.

The parking solution 334 is a method or a location of storing a vehicle associated with the user 202. The parking solution 334 can include a parking lot or a location, including free or pay location, a valet parking service, or a combination thereof. Continuing with the example, one or more of the candidate routes within the candidate set 250 can include one or more instances of the parking solution 334.

The travel mode 336 is a method or a type of travel for the user 202. The travel mode 336 can include walking, driving a vehicle, utilizing a public transportation or a transportation service, or a rental service, a combination thereof. Continuing with the example, one or more of the candidate routes within the candidate set 250 can include multiple instances of the travel mode 336, a location or a station for transferring between instances of the travel mode 336, or a combination thereof.

The computing system 100 can further include and account for a coordination mechanism 338. The coordination mechanism 338 is a method or a process for arranging different instances of the travel mode 336. The coordination mechanism 338 can search for available options, such as departure or arrival times, stations, or a combination thereof. The coordination mechanism 338 can further include a mechanism for reserving, ticketing, interfacing to arrange a pickup, or a combination thereof for utilizing the travel mode 336.

For example, the computing system 100 can use the coordination mechanism 338 to automatically reserve a ticket on a train or a bus service using the user profile 204. Also for example, the computing system 100 can contact a taxi service and arrange for a pickup at a location along the candidate route according to an estimated time of arrival at the location.

The computing system 100 can generate the navigation route 254 based on using the balancing mechanism 330 to analyze the candidate cost 252 for the candidates within the candidate set 250. Continuing with the example, the computing system 100 can use the balancing mechanism 330 to balance or adjust a significance of the time cost 306, the monetary cost 304, the physical cost 308, the safety rating 310, or a combination thereof according to the user context 210.

Continuing with the example, the computing system 100 can calculate the candidate cost 252 associated with the candidate route, the route accommodation 332 therein, or a combination thereof. The computing system 100 can use the balancing mechanism 330 to evaluate a tolerance of or a significance to the user 202 for one or more categories of the candidate cost 252.

As a more specific example, for the user context 210 of traveling to the calendar event 220 where the event participant 224 is a potential client, the user 202 may desire on-time arrival above spending any reasonable amount of money, the user may not want to exert too much physical energy for appropriate appearance, or a combination thereof. The computing system 100 can use the balancing mechanism 330 to emphasize the time cost 306, the physical cost 308, or a combination thereof over the monetary threshold 322 according to the user context 210.

Also as a more specific example, for the user context 210 of the casual designation 238 of FIG. 2 without any set instances of the calendar event 220 or reservations, the user 202 may be more open to optimizing the monetary cost 304 along with other instances of the candidate cost 252. The computing system 100 can use the balancing mechanism 330 to evaluate the candidate cost 252 appropriately according to the user context 210.

The computing system 100 can further determine the target result 248 in a variety of ways. For example, the computing system 100 can determine the target result 248 based on determining or generating the candidate set 250. The computing system 100 can determine the target result 248 based on selecting a candidate within the candidate set 250. The computing system 100 can further determine the target result 248 based on ordering or sequencing the candidate set 250.

Also for example, the computing system 100 can determine the target result 248 based on adjusting the search input 206. The computing system 100 can adjust the search input 206 or the search terms 208 of FIG. 2 therein based on the user context 210, the user profile 204, or a combination thereof. The computing system 100 can adjust the search input 206 to generate an expanded search query 340.

The expanded search query 340 is a system-generated input with additional information or detail than the search input 206 for enhancing and replacing the search input 206. The expanded search query 340 can include additional instances of the search terms 208 generated by the computing system 100.

For example, the expanded search query 340 can include the search input 206 with additional operative words, such as “AND”, “OR”, “WITHIN”, “EXACTLY”, “WITHOUT”, “BEFORE”, “AFTER”, or a combination thereof. Also for example, the expanded search query 340 can include the search input 206 with windows, ranges, maximum or minimum, conditional parameters, or a combination thereof.

As a more specific example, the computing system 100 can generate the expanded search query 340 based on adding or allowing “public transportation” or “taxi” along with a request for a route to a destination in the search input 206. Also as a more specific example, the computing system 100 can generate the expanded search query 340 including a minimum or a maximum price for the route accommodation 332, a minimum or a maximum physical activity for the navigation route 254, or a combination thereof.

The computing system 100 can generate the expanded search query 340 using the candidate cost 252, the dynamic factor adjustment 318, the dynamic threshold set 320, the balancing mechanism 330, or a combination thereof. The computing system 100 can generate the expanded search query 340 for enhancing the search input 206 according to the user context 210 or to fit the user context 210.

The computing system 100 can further determine the target result 248 based on interactions with the user 202 for a previous instance of the search input 206. The computing system 100 can determine the target result 248 using a user selection 342 from a previous instance of the search input 206.

The user selection 342 can represent a selection or a confirmation from the user 202 regarding the target result 248. The user selection 342 can indicate a utilization for the target result 248. For example, the user selection 342 can be a selection input from the user 202 selecting a specific instance of the navigation route 254, a link, a POI, or a combination thereof from within the returned results of the target result 248. Also for example, the user selection 342 can include a subsequent instance of the search input 206 including modifications or updates from the preceding instance of the search input 206.

The computing system 100 can determine the target result 248 using the user selection 342 based on using the user selection 342 as an input in addition to the search input 206. The computing system 100 can further generate the expanded search query 340 using the user selection 342. The computing system 100 can further update the balancing mechanism 330 using the user selection 342, further affecting the subsequent instances of the search input 206.

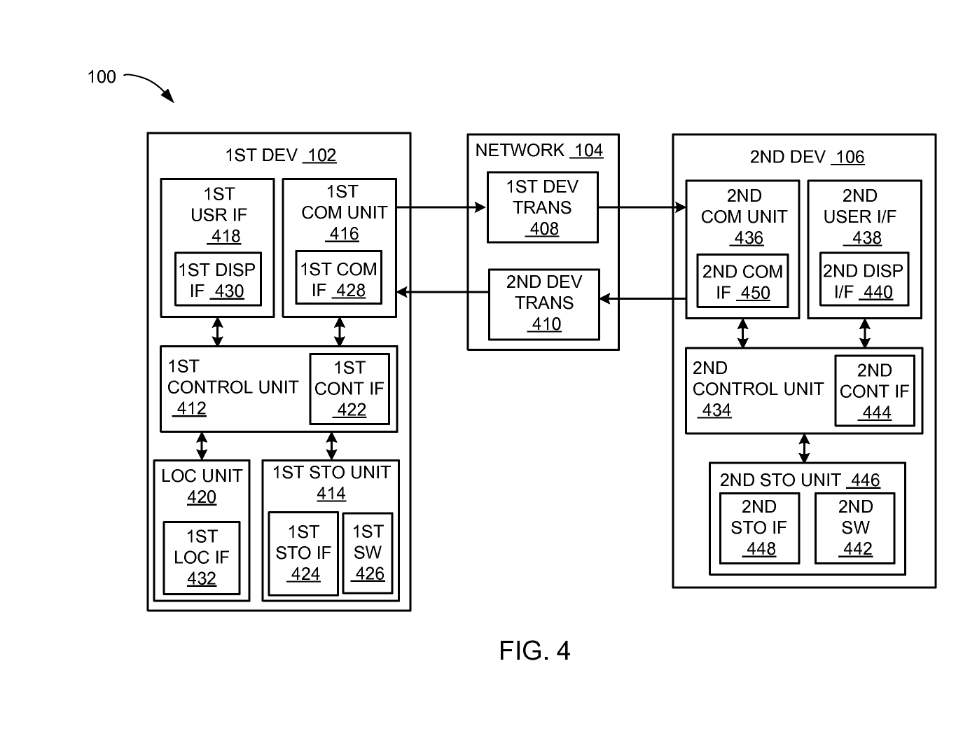

Referring now to FIG. 4, therein is shown an exemplary block diagram of the computing system 100. The computing system 100 can include the first device 102, the network 104, and the second device 106. The first device 102 can send information in a first device transmission 408 over the network 104 to the second device 106. The second device 106 can send information in a second device transmission 410 over the network 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 412, a first storage unit 414, a first communication unit 416, and a first user interface 418, and a location unit 420. The first control unit 412 can include a first control interface 422. The first control unit 412 can execute a first software 426 to provide the intelligence of the computing system 100.

The first control unit 412 can be implemented in a number of different manners. For example, the first control unit 412 can be a processor, an application specific integrated circuit (ASIC) an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations external to the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The first storage unit 414 can store the first software 426. The first storage unit 414 can also store the relevant information, such as data representing incoming images, data representing previously presented image, sound files, or a combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the first storage unit 414 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations external to the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106 of FIG. 1, an attachment, such as a peripheral device or a desktop computer, and the network 104.

The first communication unit 416 can also function as a communication hub allowing the first device 102 to function as part of the network 104 and not limited to be an end point or terminal unit to the network 104. The first communication unit 416 can include active and passive components, such as microelectronics or an antenna, for interaction with the network 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, an infrared sensor for receiving remote signals, or any combination thereof to provide data and communication inputs.

The first user interface 418 can include a first display interface 430. The first display interface 430 can include an output device. The first display interface 430 can include a display, a projector, a video screen, a speaker, or any combination thereof

The first control unit 412 can operate the first user interface 418 to display information generated by the computing system 100. The first control unit 412 can also execute the first software 426 for the other functions of the computing system 100, including receiving location information from the location unit 420. The first control unit 412 can further execute the first software 426 for interaction with the network 104 via the first communication unit 416.

The location unit 420 can generate location information, current heading, current acceleration, and current speed of the first device 102, as examples. The location unit 420 can be implemented in many ways. For example, the first location unit 420 can function as at least a part of the global positioning system, an inertial navigation system, a cellular-tower location system, a pressure location system, or any combination thereof. Also, for example, the location unit 420 can utilize components such as an accelerometer or global positioning system (GPS) receiver.

The location unit 420 can include a first location interface 432. The first location interface 432 can be used for communication between the location unit 420 and other functional units in the first device 102. The first location interface 432 can also be used for communication external to the first device 102.

The first location interface 432 can receive information from the other functional units or from external sources, or can transmit information to the other functional units or to external destinations. The external sources and the external destinations refer to sources and destinations external to the first device 102.

The first location interface 432 can include different implementations depending on which functional units or external units are being interfaced with the location unit 420. The first location interface 432 can be implemented with technologies and techniques similar to the implementation of the first control unit 412.

The second device 106 can be optimized for implementing an embodiment of the present invention in a multiple device embodiment with the first device 102. The second device 106 can provide the additional or higher performance processing power compared to the first device 102. The second device 106 can include a second control unit 434, a second communication unit 436, a second user interface 438, and a second storage unit 446.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the computing system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the computing system 100, including operating the second communication unit 436 to communicate with the first device 102 over the network 104.

The second control unit 434 can be implemented in a number of different manners. For example, the second control unit 434 can be a processor, an embedded processor, a microprocessor, hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations external to the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the information such as data representing incoming images, data representing previously presented image, sound files, or a combination thereof.. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the computing system 100 is shown with the second storage unit 446 as a single hierarchy storage system, although it is understood that the computing system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the second storage unit 446 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations external to the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the network 104.

The second communication unit 436 can also function as a communication hub allowing the second device 106 to function as part of the network 104 and not limited to be an end point or terminal unit to the network 104. The second communication unit 436 can include active and passive components, such as microelectronics or an antenna, for interaction with the network 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the network 104 to send information to the second device 106 in the first device transmission 408. The second device 106 can receive information in the second communication unit 436 from the first device transmission 408 of the network 104.

The second communication unit 436 can couple with the network 104 to send information to the first device 102 in the second device transmission 410. The first device 102 can receive information in the first communication unit 416 from the second device transmission 410 of the network 104. The computing system 100 can be executed by the first control unit 412, the second control unit 434, or a combination thereof. For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the network 104.

The functional units in the second device 106 can work individually and independently of the other functional units. The second device 106 can work individually and independently from the first device 102 and the network 104.

The functional units described above can be implemented in hardware. For example, one or more of the functional units can be implemented using the a gate, circuitry, a processor, a computer, integrated circuit, integrated circuit cores, a pressure sensor, an inertial sensor, a microelectromechanical system (MEMS), a passive device, a physical non-transitory memory medium having instructions for performing the software function, a portion therein, or a combination thereof.

For illustrative purposes, the computing system 100 is described by operation of the first device 102 and the second device 106. It is understood that the first device 102 and the second device 106 can operate any of the modules and functions of the computing system 100.

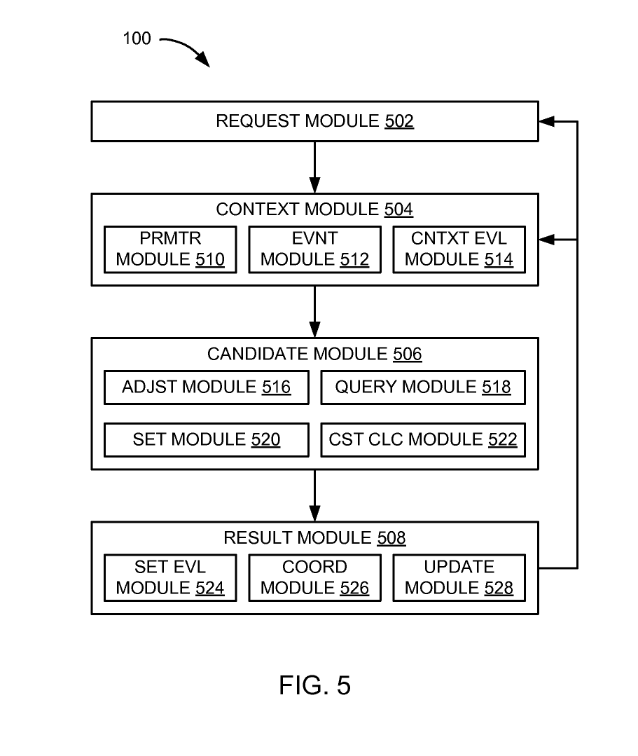

Referring now to FIG. 5, therein is shown a control flow of the computing system 100. The computing system 100 can include a request module 502, a context module 504, a candidate module 506, a result module 508, or a combination thereof

The request module 502 can be coupled to the context module 504. The context module 504 can be coupled to the candidate module 506. The candidate module 506 can be coupled to the result module 508. The result module 508 can be further coupled to the context module 504.

The modules can be coupled using wired or wireless connections, by having an output of one module as an input of the other module, by having operations of one module influence operation of the other module, or a combination thereof. The modules can be directly coupled with no intervening structures or objects other than the connector there-between, or indirectly coupled.

The request module 502 is configured to identify information sought by the user 202 of FIG. 2. The request module 502 can identify the information based on determining the search input 206 of FIG. 2.

The request module 502 can determine the search input 206 based on interacting with the user 202. The request module 502 can interact and receive the search input 206 from the user 202 through the first user interface 418 of FIG. 4, the second user interface 438 of FIG. 4, the first communication interface 428 of FIG. 4, the second communication interface 450 of FIG. 4, or a combination thereof. The request module 502 can further access the search input 206 using the first storage interface 424 of FIG. 4, the second storage interface 448 of FIG. 4, or a combination thereof.

The request module 502 can further determine the search input 206 without interacting with the user 202. The request module 502 can determine the search input 206 based on a sequence of events preceding the current time 214 of FIG. 2. The request module 502 can determine the search input 206 based on a logical connection between the preceding event and a subsequent event as predetermined by the computing system 100.

For example, the request module 502 can determine the search input 206 as a search for a parking lot following arrival at a destination with limited availability for parking according to the predetermined connection. Also for example, the request module 502 can determine the search input 206 as a search for contact information of a meeting participant after determining delay in arrival to meet the participant, after arriving at a destination following a meeting with the participant, or a combination thereof according to the predetermined connection.

The request module 502 can determine the search input 206 based on the schedule calendar 218 of FIG. 2 for the calendar event 220 of FIG. 2 approaching or within a threshold time from the current time 214. For example, the request module 502 can determine the search input 206 as a request for the navigation route 254 of FIG. 2 to the event location 226 of FIG. 2 approaching or within the threshold time from the current time 214. Also for example, the request module 502 can determine the search input 206 as a search for contact information of the event participant 224 of FIG. 2.

The request module 502 can further use the first control unit 412 of FIG. 4, the second control unit 434 of FIG. 4, the first communication unit 416, the second communication unit 436, or a combination thereof to determine the search input 206. The request module 502 can use the first display interface 430 of FIG. 4, the second display interface 440 of FIG. 4, the first communication unit 416, the second communication unit 436, or a combination thereof to display the search input 206. The request module 502 can further store the search input 206 in the first storage unit 414 of FIG. 4, the second storage unit 446 of FIG. 4, or a combination thereof.

After determining the search input 206, the control flow can pass from the request module 502 to the context module 504. For example, the control flow can pass by having a processing result, such as the search input 206 as an output from the request module 502 to an input of the context module 504.

Also for example, the control flow can further pass by storing the processing result at a location known and accessible to the context module 504. Also for example, the control flow can further pass by notifying the context module 504, such as by using a flag, an interrupt, a status signal, or a combination thereof. Also for example, the control flow can further pass using a combination of the processes described above.

The context module 504 is configured to identify a condition or a situation of the user 202. The context module 504 can identify by determine the user context 210 of FIG. 2 for the user 202. The context module 504 can determine the user context 210 associated with or connected to the search input 206, the current time 214, or a combination thereof. The context module 504 can determine the user context 210 for representing the condition or the situation of the user 202 providing the search input 206.

The context module 504 can determine the user context 210 based on the contextual parameters 212 of FIG. 2, including the schedule calendar 218, the estimated event 234 of FIG. 2, or a combination thereof. The context module 504 can further determine the user context 210 including the context type 236 of FIG. 2, the significance rating 244 of FIG. 2, the tolerance rating 246 of FIG. 2, or a combination thereof. The context module 504 can include a parameter module 510, an event module 512, a context evaluation module 514, or a combination thereof for determining the user context 210.

The parameter module 510 is configured to identify the contextual parameters 212. The parameter module 510 can identify the contextual parameters 212 based on identifying data or information from predetermined sources, sensors, devices, communications, or a combination thereof. For example, the parameter module 510 can identify the contextual parameters 212 including the current time 214, the current location 216 of FIG. 2, the schedule calendar 218, the communication profile 230 of FIG. 2, the relationship profile 232 of FIG. 2, or a combination thereof

As a more specific example, the parameter module 510 can identify the current time 214 using the first control unit 412, the second control unit 434, the first communication unit 416, the second communication unit 436, or a combination thereof. Also as a more specific example, the parameter module 510 can identify the current location 216 using the first location unit 420 of FIG. 2, the first communication unit 416, the second communication unit 436, or a combination thereof.

Also as a more specific example, the parameter module 510 can identify the calendar event 220 or the information therein, such as the event title 222 of FIG. 2, the event participant 224, the event location 226, the event start time 228 of FIG. 2, or a combination thereof. Also as a more specific example, the parameter module 510 can identify the communication profile 230, the relationship profile 232, or a combination thereof

The parameter module 510 can access the schedule calendar 218, identify the communication profile 230 or the relationship profile 232, or a combination thereof using the first control unit 412, the second control unit 434, the first communication unit 416, the second communication unit 436, the first storage unit 414, the second storage unit 446, or a combination thereof. The parameter module 510 can identify and access according to a method or a process predetermined by the computing system 100.

For example, the parameter module 510 can include a list of sources, sensors, devices, communications, or a combination thereof predetermined by the computing system 100 for identifying and accessing the data or information for the contextual parameters 212. Also for example, the parameter module 510 can further include the method or the process predetermined by the computing system 100 for recognizing and processing the contextual parameters 212, such as a timing or a condition for identifying and accessing the data or information for the contextual parameters 212.

As a more specific example, the parameter module 510 can include the predetermined method or process for observing or processing one or more sources, sensors, devices, communications, or a combination thereof at all time. Also as a more specific example, the parameter module 510 can also include the predetermined method or process for additionally accessing, observing, processing, or a combination thereof based on one or more specific values of the contextual parameters 212.

The event module 512 is configured to determine the estimated event 234. The event module 512 can determine the estimated event 234 for representing an action or an intent of the user 202. The event module 512 can determine the estimated event 234 when the contextual parameters 212 do not match the calendar event 220 in the schedule calendar 218. The event module 512 can determine the estimated event 234 for estimating actions or intent of the user 202 separate from the calendar event 220 and not within the schedule calendar 218.

For example, the event module 512 can determine the estimated event 234 when the current location 216, current direction of travel, or a combination thereof does not align or match the upcoming instance of the calendar event 220. Also for example, the event module 512 can determine the estimated event 234 based on a difference between the current time 214 and the event start time 228 of the upcoming instance of the calendar event 220.

Also for example, the event module 512 can determine the estimated event 234 using a model, a cluster, a pattern, or a combination thereof predetermine by the computing system 100. As a more specific example, the event module 512 can use a set of keywords to analyze the schedule calendar 218, the communication profile 230, the relationship profile 232, or a combination thereof. The event module 512 can determine the estimated event 234 based on the matching keywords in the schedule calendar 218, the communication profile 230, the relationship profile 232, or a combination thereof to the model, the cluster, the pattern, or a combination thereof.

The event module 512 can determine the estimated event 234 similar to the calendar event 220. For example, the event module 512 can determine the estimated event 234 including the event title 222, the event participant 224, the event location 226, the event start time 228, an estimate thereof, or a combination thereof corresponding to the estimated event 234.

The event module 512 can determine the estimated event 234 using a method or a process predetermined by the computing system 100, such as using instructions or circuitry, machine learning mechanism, pattern analysis mechanism, or a combination thereof. The event module 512 can determine the estimated event 234 based on the contextual parameters 212 or a pattern thereof.

The context evaluation module 514 is configured to determine the user context 210 from the contextual parameters 212, the estimated event 234, or a combination thereof. The context evaluation module 514 can determine the user context 210 by determining a label, a value, a cluster, a model, a categorization, or a combination thereof matching the contextual parameters 212, the user profile 204 of FIG. 2, the estimated event 234, or a combination thereof. The context evaluation module 514 can further use keywords predetermined by the computing system 100 for analyzing the contextual parameters 212 to determine a specific instance of the user context 210.

The context evaluation module 514 can further categorize the user context 210. The context evaluation module 514 can determine the context type 236 for representing the user context 210. The context evaluation module 514 can determine the context type 236 including the casual designation 238 of FIG. 2, the formal designation 240 of FIG. 2, the professional designation 242 of FIG. 2, or a combination thereof.

The context evaluation module 514 can determine the context type 236 based on the contextual parameters 212 for the current time 214. The context evaluation module 514 can determine the context type 236 based on determined instance of the user context 210.

For example, the context evaluation module 514 can include a list or a table mapping specific instances of the contextual parameters 212, the user profile 204, specific instances of the user context 210, or a combination thereof to the casual designation 238, the formal designation 240, the professional designation 242, or a combination thereof. The context evaluation module 514 can determine the context type 236 as the casual designation 238, the formal designation 240, the professional designation 242, or a combination thereof matching the contextual parameters 212, determined instance of the user context 210, or a combination thereof.

The context evaluation module 514 can further evaluate an abstract value or importance for the overall context. The context evaluation module 514 can calculate or estimate the significance rating 244, the tolerance rating 246, or a combination thereof for the user context 210.

The context evaluation module 514 can include a method, a process, an equation, or a combination thereof predetermined by the computing system 100 for calculating or estimating the significance rating 244, the tolerance rating 246, or a combination thereof for the user context 210 overall. The context evaluation module 514 can use the contextual parameters 212, the user context 210, the context type 236, the user profile 204, or a combination thereof as an input according to the predetermined method, equation, process, or a combination thereof. The context evaluation module 514 can set the corresponding result as the significance rating 244, the tolerance rating 246, or a combination thereof.

The context evaluation module 514 can dynamically calculate the significance rating 244, the tolerance rating 246, or a combination thereof. It has been discovered that the dynamic calculation of the significance rating 244, the tolerance rating 246, or a combination thereof provides increased accuracy in representing the considerations of the user 202. The significance or tolerance for utilizing or saving one cost can shift or change for the user 202 according to the user context 210. The dynamic adjustments for the significance rating 244, the tolerance rating 246, or a combination thereof can accurately reflect the resources readily available or significant to the user 202, which can be used to evaluate the target result 248 of FIG. 2 best fitting the user context 210.

The context module 504 can use the first control unit 412, the second control unit 434, the first communication unit 416, the second communication unit 436, or a combination thereof to determine the user context 210, the context type 236, or a combination thereof. The context module 504 can store the user context 210, the context type 236, or a combination thereof in the first storage unit 414, the second storage unit 446, or a combination thereof

After determining the user context 210, the context type 236, or a combination thereof, the control flow can pass from the context module 504 to the candidate module 506. The control flow can pass similarly as described above between the request module 502 and the context module 504, but using processing results of the context module 504, such as the user context 210, the context type 236, or a combination thereof.

The candidate module 506 is configured to evaluate a significance or a priority for the user 202. The candidate module 506 can evaluate by processing the dynamic factor adjustment 318 of FIG. 3, the candidate cost 252 of FIG. 2, the candidate set 250 of FIG. 2, the dynamic threshold set 320 of FIG. 3, the balancing mechanism 330 of FIG. 3, the expanded search query 340 of FIG. 3, or a combination thereof. The candidate module 506 can include an adjustment module 516, a query module 518, a set module 520, a cost calculation module 522, or a combination thereof for evaluating the significance or the priority for the user 202.

The adjustment module 516 is configured to identify and evaluate the candidate cost 252. The adjustment module 516 can identify the candidate cost 252 appropriate or matching the user context 210. The adjustment module 516 can identify or select one or more instances of the candidate cost 252 to be analyzed for the computing system 100 for various candidates.

The adjustment module 516 can identify or select based on various instances of the candidate cost 252 predetermined and linked to various possible values or instances of the user context 210, the contextual parameters 212, the user profile 204, or a combination thereof. For example, the adjustment module 516 can identify or select the monetary cost 304 of FIG. 3, the time cost 306 of FIG. 3, the physical cost 308 of FIG. 3, the safety rating 310 of FIG. 3, or a combination thereof according to resulting or detected instances of the user context 210, the contextual parameters 212, or a combination thereof from the context module 504.

The adjustment module 516 can further process the relative importance or value between instances of the candidate cost 252. The adjustment module 516 can process the relative importance or value appropriate for the user context 210. The adjustment module 516 can process the relative importance or value applicable to each instance of the candidates. The adjustment module 516 can process the relative importance or value by generating the dynamic factor adjustment 318.

The adjustment module 516 can generate the dynamic factor adjustment 318 for one or more instances of the candidate cost 252. The adjustment module 516 can generate the dynamic factor adjustment 318 based on the user context 210, the contextual parameters 212, or a combination thereof. The adjustment module 516 can further generate the dynamic factor adjustment 318 based on the balancing mechanism 330.

For example, the balancing mechanism 330 can include a method, a process, an equation, or a combination thereof using the determined instance of the user context 210, the contextual parameters, the selected instances of the candidate cost 252, or a combination thereof. The adjustment module 516 can generate the dynamic factor adjustment 318 as an order, a sequence, a weight, or a combination thereof resulting from implementing the balancing mechanism 330 with current or relevant inputs. The adjustment module 516 can generate the dynamic factor adjustment 318 for the selected or identified instances of the candidate cost 252.

The adjustment module 516 can further generate the dynamic factor adjustment 318 based on other processing results. For example, the adjustment module 516 can generate the dynamic factor adjustment 318 based on the significance rating 244, the tolerance rating 246, the context type 236, or a combination thereof for the user context 210 overall.

As a more specific example, the adjustment module 516 can generate the dynamic factor adjustment 318 by using the significance rating 244, the tolerance rating 246, or a combination thereof for the user context 210 overall as a magnitude, a quality, a quantity, or a combination thereof. The adjustment module 516 can generate the dynamic factor adjustment 318 using the significance rating 244, the tolerance rating 246, or a combination thereof for the user context 210 overall for a degree of separation or importance given to one instance of the candidate cost 252 over another.

Also as a more specific example, the adjustment module 516 can generate the dynamic factor adjustment 318 by using the significance rating 244, the tolerance rating 246, or a combination thereof an initial value for each instance of the candidate cost 252. The adjustment module 516 can calculate and update the significance rating 244, the tolerance rating 246, or a combination thereof based on the user context 210, the contextual parameters 212, the context type 236, or a combination thereof. The adjustment module 516 can update and calculate the significance rating 244, the tolerance rating 246, or a combination thereof for each instance of the candidate cost 252 using the overall value as the initial value.

Continuing with the example, the adjustment module 516 can update and calculate using the balancing mechanism 330. The adjustment module 516 can set the updated instance of the significance rating 244, the tolerance rating 246, or a combination thereof for each instance of the candidate cost 252 as the dynamic factor adjustment 318. As a more specific example, the adjustment module 516 can set the magnitude or a sequence thereof for the significance rating 244, the tolerance rating 246, or a combination thereof corresponding to each instance of the candidate cost 252 as the dynamic factor adjustment 318.

The adjustment module 516 can similarly generate the dynamic threshold set 320. The adjustment module 516 can generate the dynamic threshold set 320 for generating and limiting the candidate set 250. The adjustment module 516 can generate the dynamic threshold set 320 based on the user context 210.

For example, the adjustment module 516 can use the balancing mechanism 330 with the user context 210, the contextual parameters 212, the significance rating 244, the tolerance rating, the context type 236, or a combination thereof as input for the balancing mechanism 330. The adjustment module 516 can use the balancing mechanism 330 to generate a threshold, a limit, a condition, or a combination thereof matching or appropriate for the input as the dynamic threshold set 320. The adjustment module 516 can generate the dynamic threshold set 320 including for one or more instances, or for each instance of the candidate cost 252.

As a further illustrative example, the adjustment module 516 can generate the dynamic factor adjustment 318 for describing added emphasis or value of the time cost 306 over others for the user context 210 corresponding to the formal designation 240 and the professional designation 242. Also as a further illustrative example, the adjustment module 516 can generate the dynamic factor adjustment 318 for describing emphasis or value of the monetary cost 304 when the sufficient time exists or secondary to the time cost 306 for the user context 210 corresponding to the formal designation 240 and the professional designation 242.

Also as a further illustrative example, the adjustment module 516 can generate the dynamic factor adjustment 318 for describing emphasis or value of the monetary cost 304 for over others for the user context 210 corresponding to the professional designation 242 for certain types of businesses. Also as a further illustrative example, the adjustment module 516 can generate the dynamic factor adjustment 318 for describing emphasis or value of the monetary cost 304, the physical cost 308, the safety rating 310, a combination thereof, or a balance thereof for the user context 210 corresponding to the informal designation 240 or personal situations with low significance rating 244.

The query module 518 is configured to update or adjust the search input 206. The query module 518 can update or adjust the search input 206 by generating the expanded search query 340. The query module 518 can generate the expanded search query 340 based on the user context 210. The query module 518 can further generate the expanded search query 340 based on the search input 206.

The query module 518 can further generate the expanded search query 340 using the search input 206 as an initial starting point. The query module 518 can generate the expanded search query 340 based on generating and adding one or more new instances of the search terms 208 of FIG. 2 to the search input 206. For example, the query module 518 can generate the expanded search query 340 based on adding an operative word, such as “AND” or “OR”, a logical operator, a keyword, a word or a term related to the search input 206, or a combination thereof.

The query module 518 can generate the additional word based on the search input 206, the user context 210, the contextual parameters 212, the context type 236, the significance rating 244, the tolerance rating 246, the dynamic factor adjustment 318, the dynamic threshold set 320, or a combination thereof. The query module 518 can include a method, a process, an equation, a keyword, or a combination thereof predetermined by the computing system 100 for generating the expanded search query 340.

For example, the query module 518 can analyze the search terms 208 of the search input 206. The query module 518 can use the search terms 208, along with the user context 210, the contextual parameters 212, the context type 236, the significance rating 244, the tolerance rating 246, or a combination thereof as input to the predetermined method, process, equation, keyword set, or a combination thereof. The query module 518 can utilize the resulting keyword, operator, a related instance of the search term within the search input 206, or a combination thereof to generate the expanded search query 340.

Also for example, the query module 518 can add the dynamic threshold set 320 to the search input 206 to generate the expanded search query 340. As a more specific example, the query module 518 can use the predetermined method, process, equation, keyword set, or a combination thereof to add the threshold limit or range along with a corresponding operator to the relevant instance of the search term.

The set module 520 is configured to analyze potential candidates for the target result 248 of FIG. 2 in response to the search input 206. The set module 520 can analyze potential candidates by generating the candidate set 250. The set module 520 can generate the candidate set 250 based on the search input 206. The set module 520 can generate the candidate set 250 for representing candidate instances of the target result 248.

The set module 520 can generate the candidate set 250 by searching for information matching the search input 206. The set module 520 can generate the candidate set 250 as title, link, content, POI, location, type, document, or a combination thereof matching the search input 206.

The set module 520 can further generate the candidate set 250 based on the user context 210. The set module 520 can generate the candidate set 250 using the user context 210 in a variety of ways. For example, the set module 520 can generate the candidate set 250 directly using the search input 206, and for further processing according to the user context 210 or associated information, such as the contextual parameters 212, the context type 236, the significance rating 244, the tolerance rating 246, the dynamic factor adjustment 318, the dynamic threshold set 320, or a combination thereof. The result module 508, described below, can implement the further processing.

Also for example, the set module 520 can generate the candidate set 250 directly using the expanded search query 340. The set module 520 can search for title, link, content, POI, location, type, document, or a combination thereof matching the expanded search query 340 generated using the user context 210 or associated information, such as the contextual parameters 212, the context type 236, the significance rating 244, the tolerance rating 246, the dynamic factor adjustment 318, the dynamic threshold set 320, or a combination thereof.

Also for example, the set module 520 can further use the dynamic threshold set 320 in generating the candidate set 250. The set module 520 can use the dynamic threshold set 320 to generate the candidate set 250 relevant for and matching the user context 210. The set module 520 can use the dynamic threshold set 320 to limit the candidates during the search operation or to remove candidates after the search operation. The set module 520 can use the dynamic threshold set 320 to reduce the size of or amount of information in the candidate set 250.

It has been discovered that the candidate set 250 generated using the dynamic threshold set 320 based on the user context 210 provides lower operating cost and increased processing speed. The candidate set 250 generated using the dynamic threshold set 320 can have reduction in size or amount of information. The reduction in information can reduce amount of resources necessary to further process information and communicate to the user 202. The reduction in the resources can lead to the lower operating cost and increased processing speed.

It has also been discovered that the candidate set 250 based on the user context 210 provides lower operating cost and increased processing speed. Initial processing of the candidates according to the user context 210 can eliminate irrelevant candidates before further processing or communication.

The cost calculation module 522 is configured to quantify the burden or cost for each candidate. The cost calculation module 522 can quantify by calculating one or more instances of the candidate cost 252 corresponding to the candidate set 250. The cost calculation module 522 can calculate one or more instances of the candidate cost 252 for one or more candidate results in the candidate set 250. The cost calculation module 522 can calculate one or more instances of the candidate cost 252 for each of the results in the candidate set 250.

For example, the cost calculation module 522 can calculate the monetary cost 304, the time cost 306, the physical cost 308, the safety rating 310, or a combination thereof for representing each candidate result within the candidate set 250. The cost calculation module 522 can calculate monetary cost 304, the time cost 306, the physical cost 308, the safety rating 310, or a combination thereof selected or identified for specific instance of the user context 210.

The cost calculation module 522 can calculate the candidate cost 252 based on the user context 210 or the associated information, such as the contextual parameters 212, the context type 236, the significance rating 244, the tolerance rating 246, the dynamic factor adjustment 318, the dynamic threshold set 320, or a combination thereof. The cost calculation module 522 can calculate the candidate cost 252 using the user context 210 or the associated information as an input to a predetermined equation, method, process, or a combination thereof.

For example, the cost calculation module 522 can calculate the candidate cost 252 using an initial value corresponding to the dynamic factor adjustment 318, the user context 210, the context type 236, or a combination thereof. The cost calculation module 522 can include various instances of the initial value corresponding to different scenarios or situations.

Also for example, the cost calculation module 522 can calculate the candidate cost 252 using the significance rating 244, the tolerance rating 246, or a combination thereof for each of the candidate cost 252. The cost calculation module 522 can calculate the candidate cost 252 as the significance rating 244, the tolerance rating 246, or a combination thereof calculated or adjusted for each instance of the candidate cost 252 by the adjustment module 516. The cost calculation module 522 can further calculate the candidate cost 252 by adjusting the significance rating 244, the tolerance rating 246, or a combination thereof according to the user context 210, the contextual parameters 212, the context type 236, the dynamic factor adjustment 318, the dynamic threshold set 320, or a combination thereof.

For illustrative example, the user 202 can provide the search input 206 for requesting the navigation route 254. The request module 502 can receive the search input 206. The context module 504 can identify the user context 210 associated with the user 202 at the time of the search input 206. The context module 504 can determine the user context 210 for understanding the intent or need of the user 202 for the navigation route 254.

Continuing with the example, the candidate module 506 can use the adjustment module 516 to identify the importance or significance of various candidate costs for the user context 210. The candidate module 506 can use the query module 518 to generate the expanded search query 340 to modify the search input 206 to be more appropriate according to the user context 210.

Continuing with the example, the set module 520 can search and determine the various results that match the search input 206 or the expanded search query 340. As a more specific example, the set module 520 can calculate various candidate routes utilizing different paths, nodes, or a combination thereof. Also as a more specific example, the set module 520 can calculate the various candidate routes utilizing different instances of the route accommodation 332 of FIG. 3, such as different instances of the parking solution 334 of FIG. 3, different instances of the travel mode 336 of FIG. 3, or a combination thereof.

Continuing with the example, the cost calculation module 522 can calculate the candidate cost 252 corresponding to each of the candidate routes within the candidate set 250. As a more specific example, the cost calculation module 522 can calculate the financial cost, the estimated time of arrival, the estimated amount of physical exertion, the probability of occurrence for certain events, or a combination thereof associated with each of the candidate routes. The cost calculation module 522 can calculate the candidate cost 252 for each instance of the path, the node, the route accommodation 332, or a combination thereof.

Continuing with the example, the cost calculation module 522 can calculate the time cost 306 based on the external popularity 312 of FIG. 3 for the parking solution 334, the travel mode 336, or a combination thereof. The cost calculation module 522 can calculate the time cost 306 to include delays associated with the external popularity 312. The cost calculation module 522 can calculate the delays such as resulting from looking for an available parking spot based on the occupancy measure 314 of FIG. 3, resulting from rushes coinciding with events or known patterns according to the event-based flow 316 of FIG. 3, or a combination thereof.

It has been discovered that the dynamic factor adjustment 318 provides increased accuracy in representing the considerations of the user 202. The dynamic factor adjustment 318 can reflect the importance of certain costs or specific resources to the user 202 according to the user context 210. The direct relationship between the costs and the user context 210 can be used to evaluate candidate results according to the intent, desire, or need of the user 202 to provide the most relevant result not only in matching the search input 206 but also appropriate for the user context 210.

It has been discovered that the expanded search query 340 based on the user context 210 and the search input 206 provides increased accuracy in the target result 248. The computing system 100 can use computer-recognizable search terms and operator to enhance the accuracy of the search input 206 with the expanded search query 340. The incorporation of the user context 210 directly into the search input 206 can provide search results more appropriate for the user 202. Also, the expanded search query 340 has been discovered to reduce the amount of processed data by eliminating irrelevant results.

The candidate module 506 can use the first control unit 412, the second control unit 434, the first communication unit 416, the second communication unit 436, or a combination thereof to evaluate the significance or the priority. The candidate module 506 can store the dynamic factor adjustment 318, the dynamic threshold set 320, the candidate set 250, the candidate cost 252, or a combination thereof in the first storage unit 414, the second storage unit 446, or a combination thereof.

After evaluating the significance or the priority, the control flow can pass from the candidate module 506 to the result module 508. The control flow can pass similarly as described above between the request module 502 and the context module 504, but using processing results of the candidate module 506, such as the dynamic factor adjustment 318, the dynamic threshold set 320, the candidate set 250, the candidate cost 252, or a combination thereof.

The result module 508 is configured to provide information to the user 202 in response to the search input 206. The result module 508 can provide the information by determining the target result 248 appropriate for or matching the search input 206. The result module 508 can determine the target result 248 based on the candidate set 250. The result module 508 can determine and process the target result 248 using a set evaluation module 524, a coordination module 526, an update module 528, or a combination thereof

The set evaluation module 524 is configured to analyze the candidate set 250 for determining the target result 248. The set evaluation module 524 can determine the target result 248 based on evaluating matches or similarities to the search input 206 based on matching keywords, content, metadata, or a combination thereof for candidate result in the candidate set 250 to the search terms 208 in the search input 206. The set evaluation module 524 can determine the target result 248 in a variety of ways.

For example, the set evaluation module 524 can determine the target result 248 from the candidate set 250. The set evaluation module 524 can determine the target result 248 by selecting one or more instances of the candidate result within the candidate set 250. The set evaluation module 524 can determine the target result 248 by selecting the results matching the various factors.

The set evaluation module 524 can calculate the candidate ranking 302 of FIG. 3 for representing a degree of match or confidence for the candidate results. The set evaluation module 524 can calculate the candidate ranking 302 according to a match or a similarity between each candidate result and the search input 206 or the expanded search query 340. The set evaluation module 524 can further calculate the candidate ranking 302 according to association between or similarity in the candidate cost 252 and the dynamic factor adjustment 318.

Continuing with the example, the set evaluation module 524 can determine the target result 248 as the candidate result within the candidate set 250 with the highest instance or score for the candidate ranking 302. The set evaluation module 524 can determine the target result 248 by selecting the candidate result corresponding to the highest match or confidence as represented by the candidate ranking 302.

Also for example, the set evaluation module 524 can determine the target result 248 by arranging the results within the candidate set 250. The set evaluation module 524 can arrange the results according to the candidate ranking 302 representing matching or similarities the various factors in each candidate result to the dynamic factor adjustment 318 or the user context 210. The set evaluation module 524 can determine the target result 248 as the candidate set 250 rearranged or prioritized according to the candidate ranking 302.

The set evaluation module 524 can further determine the target result 248 based on evaluating the candidate set 250 according to various factors. For example, the set evaluation module 524 can determine the target result 248, calculate the candidate ranking 302, or a combination thereof based on the candidate cost 252, the dynamic factor adjustment 318, the dynamic threshold set 320, the significance rating 244, the tolerance rating 246, the context type 236, the estimated event 234, or a combination thereof.

As a more specific example, the set evaluation module 524 can evaluate the candidate cost 252 of the candidate result according to the dynamic factor adjustment 318, the balancing mechanism 330, or a combination thereof. The set evaluation module 524 can calculate the candidate ranking 302 or determine the target result 248 based on assigning high rank or score to the candidate result with the prioritized instance of the candidate cost 252 satisfying the user context 210 according to the dynamic factor adjustment 318. The set evaluation module 524 can calculate the candidate ranking 302 or determine the target result 248 based on similarly prioritizing or sequencing the candidate set 250.

Also as a more specific example, the set evaluation module 524 can evaluate the candidate result using the balancing mechanism 330. The set evaluation module 524 can combine the monetary cost 304, the time cost 306, the physical cost 308, the safety rating 310, or a combination thereof according to the balancing mechanism 330 to calculate the candidate ranking 302. The set evaluation module 524 can determine the target result 248 based on the candidate ranking 302.

The set evaluation module 524 can determine the target result 248 based on the estimated event 234. The set evaluation module 524 can determine the target result 248 from the user context 210 including the estimated event 234. For example, the set evaluation module 524 can determine the target result 248 appropriate for the user 202 attending or travelling to the estimated event 234 not included in the schedule calendar 218.

Continuing with the illustrative example, the set evaluation module 524 can determine the target result 248 as the navigation route 254 or a set of routes for reaching the destination provided in the search input 206. The set evaluation module 524 can determine the target result 248 as the navigation route 254 best fitting or most appropriate for the user context 210 based on the dynamic factor adjustment 318 and the candidate cost 252.

As a more specific example, the set evaluation module 524 can determine the target result 248 as the navigation route 254 minimizing the time cost 306, the physical cost 308, or a combination thereof for travelling to the calendar event 220 or the estimated event 234 with the formal designation 240 and the professional designation 242. Also as a more specific example, the set evaluation module 524 can determine the target result 248 as the navigation route 254 minimizing the monetary cost 304 for the user 202 travelling on a budget for the casual designation 238, for a small business owner for the casual designation 238 and the professional designation 242, for the user context 210 with the time cost 306 irrelevant or less important than the monetary cost 304, or a combination thereof.

The set evaluation module 524 can determine the target result 248 using the first control unit 412, the second control unit 434, the first communication unit 416, the second communication unit 436, or a combination thereof. The set evaluation module 524 can store the target result 248 in the first storage unit 414, the second storage unit 446, or a combination thereof.

The set evaluation module 524 can further communicate the target result 248 between device using the first communication unit 416, the second communication unit 436, interfaces, or a combination thereof. The set evaluation module 524 can further communicate the target result 248 to the user 202, such as by displaying or audibly recreating the information, through the first user interface 418, the second user interface 438, other interfaces, or a combination thereof.

The set evaluation module 524 can further interact with the user 202 regarding the target result 248. The set evaluation module 524 can receive the user selection 342 of FIG. 3 from the user 202 for the target result 248 using the first user interface 418, the second user interface 438, other interfaces, or a combination thereof. The set evaluation module 524 can further store the user selection 342 in the first storage unit 414, the second storage unit 446, or a combination thereof.

The set evaluation module 524 can initiate implementation of further processing for the target result 248 based on the user selection 342. For example, the set evaluation module 524 can start an application, start navigational guidance, start interacting with another device, initiate a feature, or a combination thereof.

It has been discovered that the target result 248 based on balancing multiple instances of the candidate cost 252 according to the user context 210 provides increased usability. The balancing of multiple instances of the candidate cost 252 can simultaneously and dynamically evaluate multiple factors important to the user 202. The processing of the multiple costs can be used to generate the target result 248 most relevant to the user 202 for the user context 210 without added search terms or multiple searches.

It has further been discovered that the target result 248 based on the dynamic factor adjustment 318 corresponding to the user context 210 for the search input 206 provides increased accuracy in representing the considerations of the user 202. The dynamic factor adjustment 318 can reflect the importance of certain costs or specific resources to the user 202 according to the user context 210. The direct relationship between the costs and the user context 210 can be used to evaluate candidate results according to the intent, desire, or need of the user 202 to provide the most relevant result not only in matching the search input 206 but also appropriate for the user context 210.

It has further been discovered that the navigation route 254 as the target result 248 determined based on balancing at least two of the candidate cost 252 including the time cost 306, the physical cost 308, the monetary cost 304, or a combination thereof relevant to the user context 210 provides maximization of user's resources. The dynamic balancing of two or more factors can identify in real-time can identify the important resource for user's situation or condition. The navigation route 254 can account for the importance of the resources, allowing the user 202 to find best solutions with minimal interaction or time.

It has further been discovered that target result 248 including the parking solution 334 from balancing the costs according to the user context 210 provides increase in relevancy for the navigation route 254. The parking solution 334 accounting for the user context 210 can allow the user 202 to use readily available resources to maximize the most desired resource for the overall goal.

The control flow can further pass to the request module 502 based on the user selection 342 or the lack thereof. The request module 502 can receive an updated instance of the search input 206 when the user 202 wishes for a result different from the target result 248 or the candidate set 250.

The coordination module 526 is configured to interact with other devices or services in implementing the target result 248. The coordination module 526 can implement the coordination mechanism 338 of FIG. 3 for interacting with other devices or services.

For example, the coordination module 526 can interact with the parking solution 334, the travel mode 336, or a combination thereof included in the navigation route 254 determined to be the target result 248. As a more specific example, the coordination module 526 can contact the parking solution 334, the travel mode 336, or a combination thereof, reserve resources, arrange for resources according to estimated time of arrival, arrange a meeting location or search for appropriate station, or a combination thereof.

The coordination module 526 can implement the coordination mechanism 338 using the target result 248 or a portion therein. For example, the coordination module 526 can interact with the parking solution 334 or a transfer station for the travel mode 336 in the navigation route 254. Also for example, the coordination module 526 can use estimated times of arrival for reservations, pickups, or a combination thereof.

It has been discovered that the coordination mechanism 338 reserving and scheduling the route accommodation 332 for implementing the navigation route 254 for the target result 248 provides improved efficiency in traversing to a destination. The coordination mechanism 338 can be used in considering multiple modes for the navigation route 254. The coordination mechanism 338 can be used to dynamically calculate and coordinate the best sequence of travel modes, especially when time is important.

The update module 528 is configured to process and use the user selection 342 from a previous instance of the target result 248 for other subsequent instances of the search input 206. The update module 528 can store the current instance of the user selection 342 for subsequent use. The update module 528 can store the current instance of the user selection 342 in the user profile 204.

The context module 504 can use the stored instance of the user selection 342 and corresponding instance of the search input 206 as part of the user context 210 for subsequent instances of the search input 206. The context module 504 can identify the user selection 342 corresponding to a previous instance of the target result 248 based on similarities or matches between the previous and current instance of the search input 206.

The candidate module 506 can use the user selection 342 in processing the candidate set 250. The set evaluation module 524 can use the user selection 342 for previous targets and searches in determining the target result 248 for the current process.

The result module 508 can further use the user selection 342 to update or adjust the balancing mechanism 330. The result module 508 can use the user selection 342 as a confirmation or a match for the target result 248 for the search input 206 under the specific instance of the user context 210. The result module 508 can update or adjust the balancing mechanism 330 with the user selection 342 in a variety of ways. For example, the result module 508 can update or adjust the balancing mechanism 330 using a machine language mechanism, a pattern analysis mechanism, or a combination thereof.

The computing system 100 can use the updated or adjusted instance of the balancing mechanism 330 for subsequent instances of the search input 206. The computing system 100 can thus utilize an adaptive instance of the balancing mechanism 330 for the user 202 based on the user selection 342.

It has been discovered that the target result 248 determined using the balancing mechanism 330 updated or adjusted based on the user selection 342 and the user context 210 provides personalization of the target result 248. The user's thought pattern, priority, and preference can be learned by updating or adjusting the balancing mechanism 330 using the user selection 342. The updates and adjustments can personalize the balancing mechanism 330 to reflect the pattern, priority, and preference for specific instances the user 202, which can be used to evaluate the candidate cost 252 in determining the target result 248.

The modules described in this application can be hardware implementation or hardware accelerators, including passive circuitry, active circuitry, or both, in the first storage unit 414, the second storage unit 446, the first control unit 412, the second control unit 434, or a combination thereof. The modules can also be hardware implementation or hardware accelerators, including passive circuitry, active circuitry, or both, within the first device 102, the second device 106, or a combination thereof but outside of the first storage unit 414, the second storage unit 446, the first control unit 412, the second control unit 434, or a combination thereof.

The computing system 100 has been described with module functions or order as an example. The computing system 100 can partition the modules differently or order the modules differently. For example, the request module 502 can be implemented in parallel to the context module 504. Also for example, the candidate module 506 and the result module 508 can be combined.

For illustrative purposes, the various modules have been described as being specific to the first device 102 or the second device 106. However, it is understood that the modules can be distributed differently. For example, the various modules can be implemented in a different device, or the functionalities of the modules can be distributed across multiple devices. Also as an example, the various modules can be stored in a non-transitory memory medium

As a more specific example, one or more modules described above can be stored in the non-transitory memory medium for distribution to a different system, a different device, a different user, or a combination thereof, for manufacturing, or a combination thereof. Also as a more specific example, the modules described above can be implemented or stored using a single hardware unit, such as a chip or a processor, or across multiple hardware units.

The modules described in this application can be stored in the non-transitory computer readable medium. The first storage unit 414, the second storage unit 446, or a combination thereof can represent the non-transitory computer readable medium. The first storage unit 414, the second storage unit 446, or a combination thereof, or a portion therein can be removable from the first device 102, the second device 106, or a combination thereof. Examples of the non-transitory computer readable medium can be a non-volatile memory card or stick, an external hard disk drive, a tape cassette, or an optical disk.

The physical transformation from the target result 248 based on the dynamic factor adjustment 318 and the user context 210 results in the movement in the physical world, such as physical change in information communicated for the user on one or more of the devices or physical displacement of the user 202 carrying the first device 102. Movement in the physical world results in updates to the contextual parameters 212, which can be fed back into the computing system 100 and further influence or update the balancing mechanism 330, the user context 210, the dynamic factor adjustment 318, the candidate cost 252, the target result 248, or a combination thereof.

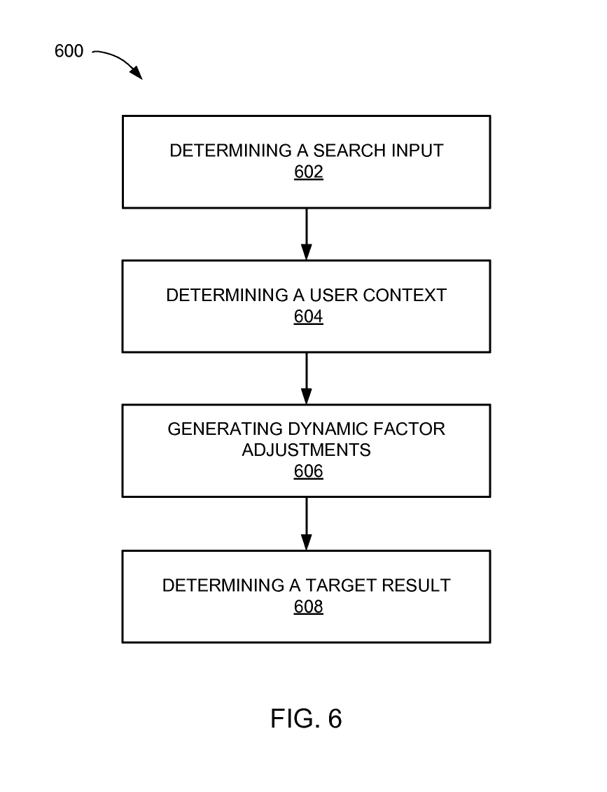

Referring now to FIG. 6, therein is shown a flow chart of a method 600 of operation of a computing system 100 in an embodiment of the present invention. The method 600 includes: determining a search input in a block 602; determining a user context associated with the search input for representing the user providing the searching input in a block 604; generating dynamic factor adjustments for candidate costs based on the user context in a block 606; and determining a target result based on the dynamic factor adjustment and the candidate costs in response to the search input in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method of operation of a computing system comprising:
determining a search input;
determining a user context associated with the search input for representing the user providing the search input;
generating dynamic factor adjustments for candidate costs based on the user context; and
determining a target result based on the dynamic factor adjustments and the candidate costs in response to the search input.

2. The method as claimed in claim 1 further comprising:
calculating significance ratings for the candidate costs based on the user context; and
wherein:
determining the target result includes determining the target result based on the significance ratings corresponding to the candidate costs.

3. The method as claimed in claim 1 further comprising:
calculating tolerance ratings for the candidate costs based on the user context; and
wherein:
determining the target result includes determining the target result based on the tolerance ratings corresponding to the candidate costs.

4. The method as claimed in claim 1 wherein:
determining the user context includes determining a context type for representing the user context; and
determining the target result includes determining the target result based on the context type.

5. The method as claimed in claim 1 wherein determining the target result includes:
generating an expanded search query based on the user context and the search input; and
determining the target result matching the expanded search query.

6. The method as claimed in claim 1 further comprising:
generating a candidate set based on the search input and the user context, the candidate set for representing candidate instances of the target result;
calculating the candidate costs corresponding to the candidate set based on the user context; and
wherein:
determining the target result includes determining the target result from the candidate set based on the candidate costs.

7. The method as claimed in claim 6 further comprising:
generating a dynamic threshold set based on the user context for limiting the candidate set; and
wherein:
generating the candidate set includes generating the candidate set based on the dynamic threshold set.

8. The method as claimed in claim 6 wherein calculating the candidate costs includes calculating the candidate costs including a monetary cost, a time cost, a physical cost, a safety rating, or a combination thereof for representing each candidate result within the candidate set.

9. The method as claimed in claim 6 wherein:
determining the user context includes determining an estimated event for representing the user; and
determining the target result includes determining the target result based on the estimated event.

10. The method as claimed in claim 6 further comprising:
identifying a user selection corresponding to a previous instance of the target result, the user selection for representing an input from the user regarding the previous instance of the target result;
adjusting a balancing mechanism based on the user selection, the balancing mechanism for processing the candidate costs according to the user context; and
wherein:
determining the target result includes determining the target result using the balancing mechanism based on the user selection.

11. A computing system comprising:
a storage interface configured to determine a search input; and
a control unit, coupled to the storage interface, configured to:
determine a user context associated with the search input for representing the user providing the search input,
generate dynamic factor adjustments for candidate costs based on the user context, and
determine a target result based on the dynamic factor adjustment and the candidate costs in response to the search input.

12. The system as claimed in claim 11 wherein the control unit is configured to:
calculate significance ratings for the candidate costs based on the user context; and
determine the target result based on the significance ratings corresponding to the candidate costs.

13. The system as claimed in claim 11 wherein the control unit is configured to:
calculate tolerance ratings for the candidate costs based on the user context; and
determine the target result based on the tolerance ratings corresponding to the candidate costs.

14. The system as claimed in claim 11 wherein the control unit is configured to:
determine a context type for representing the user context; and
determine the target result based on the context type.

15. The system as claimed in claim 11 wherein the control unit is configured to:
generate an expanded search query based on the user context and the search input; and
determine the target result matching the expanded search query.

16. A non-transitory computer readable medium including instructions for a computing system comprising:
determining a search input;
determining a user context associated with the search input for representing the user providing the search input;
generating dynamic factor adjustments for candidate costs based on the user context; and
determining a target result based on the dynamic factor adjustment and the candidate costs in response to the search input.

17. The non-transitory computer readable medium as claimed in claim 16 further comprising:
calculating significance ratings for the candidate costs based on the user context; and
wherein:
determining the target result includes determining the target result based on the significance ratings corresponding to the candidate costs.

18. The non-transitory computer readable medium as claimed in claim 16 further comprising:
calculating tolerance ratings for the candidate costs based on the user context; and
wherein:
determining the target result includes determining the target result based on the tolerance ratings corresponding to the candidate costs.

19. The non-transitory computer readable medium as claimed in claim 16 wherein:
determining the user context includes determining a context type for representing the user context; and
determining the target result includes determining the target result based on the context type.

20. The non-transitory computer readable medium as claimed in claim 16 wherein determining the target result includes:
generating an expanded search query based on the user context and the search input; and
determining the target result matching the expanded search query.
